(19) United States
(12) Patent Application Publication
(10) Pub. No.: US 2015/0312561 A1
(43) Pub. Date: Oct. 29, 2015

(54) VIRTUAL 3D MONITOR

(71) Applicant: Microsoft Technology Licensing, LLC, Redmond, WA (US)

(72) Inventors: Jonathan Ross Hoof, Kenmore, WA (US); Soren Hannibal Nielsen, Kirkland, WA (US); Brian Mount, Seattle, WA (US); Stephen Latta, Seattle, WA (US); Adam Poulos, Redmond, WA (US); Daniel McCulloch, Kirkland, WA (US); Darren Bennett, Seattle, WA (US); Ryan Hastings, Seattle, WA (US); Jason Scott, Kirkland, WA (US)

(21) Appl. No.: 14/738,219

(22) Filed: Jun. 12, 2015

Related U.S. Application Data
(63) Continuation-in-part of application No. 13/312,604, filed on Dec. 6, 2011.

(51) Int. Cl. H04N 13/04; H04N 13/02; G06T 19/00; G06T 19/20; G02B 27/01; G02B 27/00

(52) U.S. Cl. CPC H04N 13/0429; G02B 27/0172; G02B 27/0093; H04N 13/0484; G06T 19/006; G06T 19/20; H04N 13/0495; H04N 13/0221; G02B 2027/0178; H04N 2213/005

(57) ABSTRACT

A right near-eye display displays a right-eye virtual object, and a left near-eye display displays a left-eye virtual object. A first texture derived from a first image of a scene as viewed from a first perspective is overlaid on the right-eye virtual object and a second texture derived from a second image of the scene as viewed from a second perspective is overlaid on the left-eye virtual object. The right-eye virtual object and the left-eye virtual object cooperatively create an appearance of a pseudo 3D video perceivable by a user viewing the right and left near-eye displays.

### CROSS REFERENCE TO RELATED APPLICATIONS

This application is a continuation-in-part of U.S. Ser. No. 13/312,604, filed Dec. 6, 2011, the entirety of which is hereby incorporated herein by reference.

### BACKGROUND

Visual media content may be presented using a variety of techniques, including displaying via television or computer graphical display, or projecting onto a screen. These techniques are often limited by a variety of physical constraints, such as the physical size of display devices or the physical locations at which display devices may be used.

### BRIEF DESCRIPTION OF THE DRAWINGS

FIG. 1 depicts a human subject, as a user of a virtual reality system, viewing a real-world environment through a see-through, wearable, head-mounted display device.

FIG. 2 depicts an example display device.

FIG. 3 depicts selected display and eye-tracking aspects of a display device that includes an example see-through display panel.

FIG. 4 depicts a top view of a user wearing a head-mounted display device.

FIG. 5 depicts an unaltered first-person perspective of the user of FIG. 4.

FIG. 6 depicts a first-person perspective of the user of FIG. 4 while the head-mounted display device augments reality to visually present virtual monitors.

FIG. 7 is a flow diagram depicting an example method of augmenting reality.

FIG. 8 depicts an example processing pipeline for creating a virtual surface overlaid with different right-eye and left-eye textures derived from different two-dimensional images having different perspectives of the same three-dimensional scene.

FIG. 9 is a flow diagram depicting an example virtual reality method.

FIG. 10 is a flow diagram depicting an example method of changing an image-capture perspective and/or an apparent real-world position of a virtual surface.

FIGS. 11-14 depict example relationships between a gaze axis, viewing axes of right-eye and left-eye image-capture perspectives, and an apparent real-world position of a virtual surface.

FIG. 15 schematically depicts an example computing system.

### DETAILED DESCRIPTION

The present disclosure is directed to the fields of virtual reality and augmented reality. The term “virtual reality” is used herein to refer to partial augmentation or complete replacement of a human subject's visual and/or auditory perception of a real-world environment. The term “augmented reality” is a subset of virtual reality used herein to refer to partial augmentation of a human subject's visual and/or auditory perception, in contrast to fully immersive forms of virtual reality. Visual augmented reality includes modification of a subject's visual perception by way of computer-generated graphics presented within a direct field of view of a user or within an indirect, graphically reproduced field of view of the user.

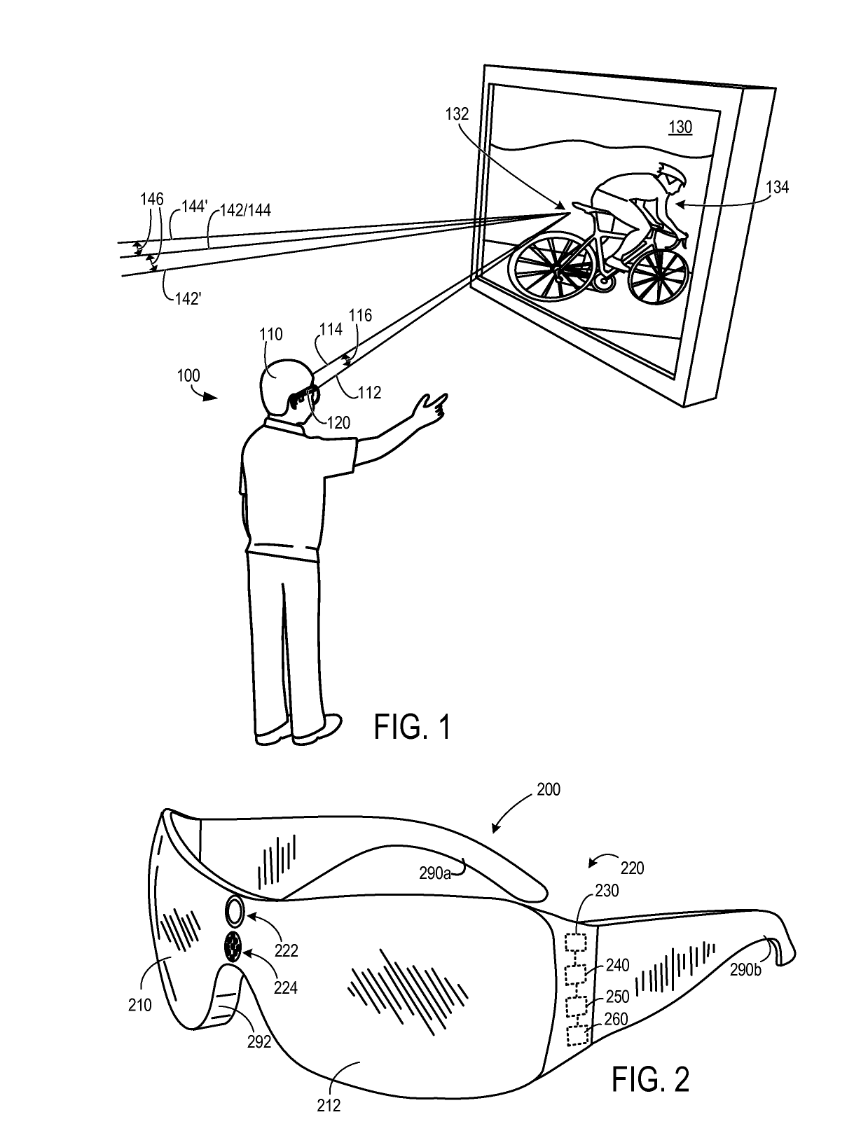

FIG. 1 depicts a human subject, as a user 110 of a virtual reality system 100, viewing a real-world environment through left near-eye and right near-eye see-through displays of a wearable, head-mounted display device 120. Graphical content displayed by the left-eye and right-eye displays of display device 120 may be operated to visually augment a physical space of the real-world environment perceived by the user.

In FIG. 1, a right-eye viewing axis 112 and a left-eye viewing axis 114 of the user are depicted converging to a focal point 132 at a virtual surface 130. In this example, a right-eye virtual object representing a right-eye view of virtual surface 130 is displayed to a right-eye of the user via the right-eye display. A left-eye virtual object representing a left-eye view of virtual surface 130 is displayed to a left-eye of the user via the left-eye display. Visually perceivable differences between the right-eye virtual object and the left-eye virtual object cooperatively create an appearance of virtual surface 130 that is perceivable by the user viewing the right-eye and left-eye displays. In this role, display device 120 provides user 110 with a three-dimensional (3D) stereoscopic viewing experience with respect to virtual surface 130.

Graphical content in the form of textures may be applied to the right-eye virtual object and the left-eye virtual object to visually modify the appearance of the virtual surface. A texture may be derived from a two-dimensional (2D) image that is overlaid upon a virtual object. Stereoscopic left-eye and right-eye textures may be derived from paired 2D images of a scene captured from different perspectives. Within the context of a 3D video content item, paired images may correspond to paired left-eye and right-eye frames encoded within the video content item. Within the context of a navigable 3D virtual world of a computer game or other virtual world, the paired images may be obtained by rendering the 3D virtual world from two different perspectives.

A first image-capture axis 142 and a second image-capture axis 144 are depicted in FIG. 1. The first and second image-capture axes represent different perspectives that respective right and left cameras had when capturing the scene overlaid on the virtual surface. In particular, a first texture derived from a first image captured by a first camera viewing a bicycling scene from first image-capture axis 142 is overlaid on a right-eye virtual object of the virtual surface; and a second texture derived from a second image captured by a second camera viewing the same bicycling scene from second image-capture axis 144 is overlaid on a left-eye virtual object of the virtual surface. The first and second textures overlaid upon the right-eye and left-eye virtual objects collectively provide the appearance of 3D video 134 being displayed on, at, or by virtual surface 130. Virtual surface 130 with the appearance of 3D video 134 overlaid thereon may be referred to as a virtual 3D monitor.

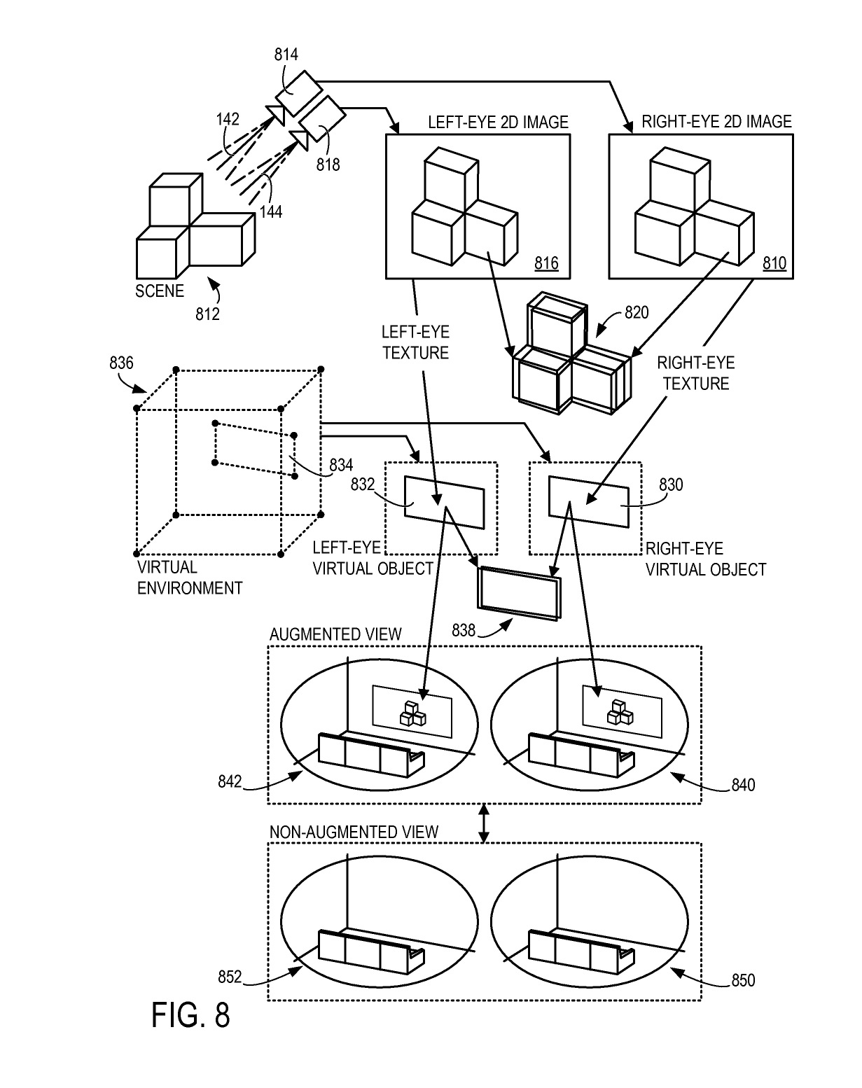

When displayed in the real world environment relative to the virtual surface 130, both first image-capture axis 142 and second image-capture axis are perpendicular to the virtual surface 130. However, only the right eye sees the texture captured from the first image-capture axis 142; and only the left eye sees the texture captured from the second image-capture axis 142. Because the first image-capture axis 142 and the second image capture axis 144 are skewed relative to one another at the time the images/textures are captured, the right and left eyes see skewed versions of the same scene on the virtual surface 130. At 144′, FIG. 1 shows the relative position image-capture axis 144 had relative to image-capture axis 142 at the time of capture. Likewise, at 142′, FIG. 1 shows the relative position image-capture axis 142 had relative to image-capture axis 144 at the time of capture. FIG. 8 shows first image-capture axis 142 and second image-capture axis 144 at the time of capture.

FIG. 1 depicts an example of the left-eye and right-eye perspectives of the user differing from the first and second image-capture perspectives of the 2D images. For example, first image-capture axis 142 of the first perspective is skewed relative to right-eye gaze axis 112 from a right eye of user 110 to the apparent real-world position of the virtual surface 130. Second image-capture axis 144 of the second perspective is skewed relative to left-eye gaze axis 114 from a left eye of user 110 to the apparent real-world position of virtual surface 130. The left- and right-eye gaze axes will change as the user moves relative to the virtual surface. In contrast, the first and second image-capture axes do not change as the user moves. By decoupling the right-eye and left-eye perspectives of the user within the virtual reality or augmented reality environment from the right-eye and left-eye image-capture perspectives, the virtual surface 130 has the appearance of a conventional 3D television or movie screen. The user can walk around the virtual surface and look at it from different angles, but the virtual surface will appear to display a same pseudo-3D view of the bicycling scene from the different viewing angles.

FIG. 1 further depicts an example of a geometric relationship represented by angle 116 (i.e., the viewing convergence angle) between right-eye and left-eye viewing axes 112, 114 differing from a geometric relationship represented by angle 146 (i.e., the image-capture convergence angle) between first and second image-capture axes 142, 144 for focal point 132. In another example, an image-capture convergence angle between the first and second image-capture axes 142, 144 may be the same as or may approximate a viewing convergence angle between the right-eye and left-eye viewing axes 112, 114.

FIG. 2 shows a non-limiting example of a display device 200. In this example, display device 200 takes the form of a wearable, head-mounted display device that is worn by a user. Display device 200 is a non-limiting example of display device 120 of FIG. 1. It will be understood that display device 200 may take a variety of different forms from the configuration depicted in FIG. 2.

Display device 200 includes one or more display panels that display computer generated graphics. In this example, display device 200 includes a right-eye display panel 210 for right-eye viewing and a left-eye display panel 212 for left-eye viewing. A right-eye display, such as right-eye display panel 210 is configured to display right-eye virtual objects at right-eye display coordinates. A left-eye display, such as left-eye display panel 212 is configured to display left-eye virtual objects at left-eye display coordinates.

Typically, right-eye display panel 210 is located near a right eye of the user to fully or partially cover a field of view of the right eye, and left-eye display panel 212 is located near a left eye of the user to fully or partially cover a field of view of the left eye. In this context, right and left-eye display panels 210, 212 may be referred to as right and left near-eye display panels.

In another example, a unitary display panel may extend over both right and left eyes of the user, and provide both right-eye and left-eye viewing via right-eye and a left-eye viewing regions of the unitary display panel. The term right-eye “display” may be used herein to refer to a right-eye display panel as well as a right-eye display region of a unitary display panel. Similarly, the term left-eye “display” may be used herein to refer to both a left-eye display panel as well as a left-eye display region of a unitary display panel. In each of these implementations, the ability of display device 200 to separately display different right-eye and left-eye graphical content via right-eye and left-eye displays may be used to provide the user with a stereoscopic viewing experience.

Right-eye and left-eye display panels 210, 212 may be at least partially transparent or fully transparent, enabling a user to view a real-world environment through the display panels. In this context, a display panel may be referred to as a see-through display panel, and display device 200 may be referred to as an augmented reality display device or see-through display device.

Light received from the real-world environment passes through the see-through display panel to the eye or eyes of the user. Graphical content displayed by right-eye and left-eye display panels 210, 212, if configured as see-through display panels, may be used to visually augment or otherwise modify the real-world environment viewed by the user through the see-through display panels. In this configuration, the user is able to view virtual objects that do not exist within the real-world environment at the same time that the user views physical objects within the real-world environment. This creates an illusion or appearance that the virtual objects are physical objects or physically present light-based effects located within the real-world environment.

Display device 200 may include a variety of on-board sensors forming a sensor subsystem 220. A sensor subsystem may include one or more outward facing optical cameras 222 (e.g., facing away from the user and/or forward facing in a viewing direction of the user), one or more inward facing optical cameras 224 (e.g., rearward facing toward the user and/or toward one or both eyes of the user), and a variety of other sensors described herein. One or more outward facing optical cameras (e.g., depth cameras) may be configured to observe the real-world environment and output observation information (e.g., depth information across an array of pixels) for the real-world environment observed by the one or more outward facing optical cameras.

Display device 200 may include an on-board logic subsystem 230 that includes one or more processor devices and/or logic machines that perform the processes or operations described herein, as defined by instructions executed by the logic subsystem. Such processes or operations may include generating and providing image signals to the display panels, receiving sensory signals from sensors, and enacting control strategies and procedures responsive to those sensory signals. Display device 200 may include an on-board data storage subsystem 240 that includes one or more memory devices holding instructions (e.g., software and/or firmware) executable by logic subsystem 230, and may additionally hold other suitable types of data. Logic subsystem 230 and data-storage subsystem 240 may be referred to collectively as an on-board controller or on-board computing device of display device 200.

Display device 200 may include a communications subsystem 250 supporting wired and/or wireless communications with remote devices (i.e., off-board devices) over a communications network. As an example, the communication subsystem may be configured to wirelessly receive a video stream, audio stream, coordinate information, virtual object descriptions, and/or other information from remote devices to render virtual objects and textures simulating a virtual monitor.

Display device 200 alone or in combination with one or more remote devices may form a virtual reality system that performs or otherwise implements the various processes and techniques described herein. The term “virtual reality engine” may be used herein to refer to logic-based hardware components of the virtual reality system, such as logic-subsystem 230 of display device 200 and/or a remote logic-subsystem (of one or more remote devices) that collectively execute instructions in the form of software and/or firmware to perform or otherwise implement the virtual/augmented reality processes and techniques described herein. For example, the virtual reality engine may be configured to cause a see-through display device to visually present left-eye and right-eye virtual objects that collectively create the appearance of a virtual monitor displaying pseudo 3D video. In at least some implementations, virtual/augmented reality information may be programmatically generated or otherwise obtained by the virtual reality engine. Hardware components of the virtual reality engine may include one or more special-purpose processors or logic machines, such as a graphics processor, for example. Additional aspects of display device 200 will be described in further detail throughout the present disclosure.

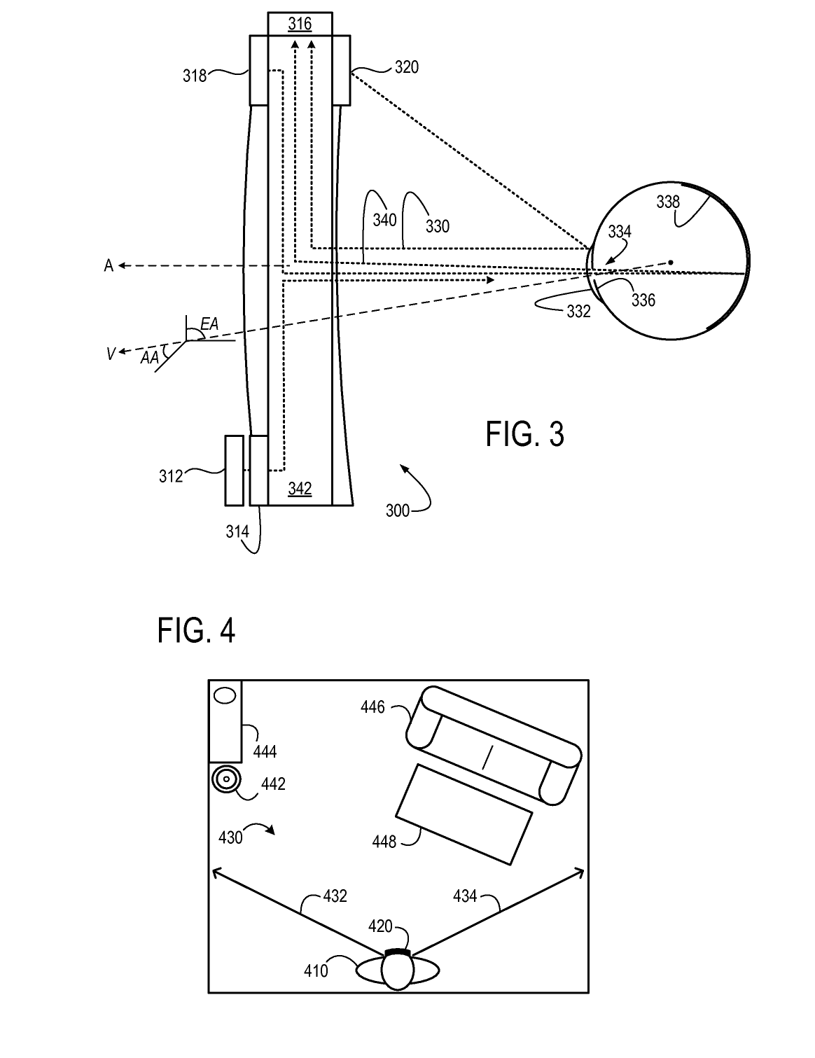

FIG. 3 shows selected display and eye-tracking aspects of a display device that includes an example see-through display panel 300. See-through display panel 300 may refer to a non-limiting example of previously described display panels 210, 212 of FIG. 2.

In some implementations, the selection and positioning of virtual objects displayed to a user via a display panel, such as see-through display panel 300, may be based, at least in part, on a gaze axis. In an example, a gaze axis may include an eye-gaze axis of an eye or eyes of a user. Eye-tracking may be used to determine an eye-gaze axis of the user. In another example, a gaze axis may include a device-gaze axis of the display device.

See-through display panel 300 includes a backlight 312 and a liquid-crystal display (LCD) type microdisplay 314. Backlight 312 may include an ensemble of light-emitting diodes (LEDs)—e.g., white LEDs or a distribution of red, green, and blue LEDs. Light emitted by backlight 312 may be directed through LCD microdisplay 314, which forms a display image based on control signals from a controller (e.g., the previously described controller of FIG. 2). LCD microdisplay 314 may include numerous, individually addressable pixels arranged on a rectangular grid or other geometry. In some implementations, pixels transmitting red light may be juxtaposed to pixels transmitting green and blue light, so that LCD microdisplay 314 forms a color image. In some implementations, a reflective liquid-crystal-on-silicon (LCOS) microdisplay or a digital micromirror array may be used in lieu of LCD microdisplay 314. Alternatively, an active LED, holographic, or scanned-beam microdisplay may be used to form display images.

See-through display panel 300 further includes an eye-imaging camera 316, an on-axis illumination source 318, and an off-axis illumination source 320. Eye-imaging camera 316 is a non-limiting example of inward facing camera 224 of FIG. 2. Illumination sources 318, 320 may emit infrared (IR) and/or near-infrared (NIR) illumination in a high-sensitivity wavelength band of eye-imaging camera 316. Illumination sources 318, 320 may each include or take the form of a light-emitting diode (LED), diode laser, discharge illumination source, etc. Through any suitable objective-lens system, eye-imaging camera 316 detects light over a range of field angles, mapping such angles to corresponding pixels of a sensory pixel array. A controller, such as the previously described controller of FIG. 2, receives and is configured to determine a gaze axis (V) (i.e., an eye-gaze axis) based on the sensor information (e.g., digital image data) output from eye-imaging camera 316.

On-axis and off-axis illumination sources, such as 318, 320 may serve different purposes with respect to eye tracking. An off-axis illumination source may be used to create a specular glint 330 that reflects from a cornea 332 of the user's eye. An off-axis illumination source may also be used to illuminate the user's eye for a ‘dark pupil’ effect, where pupil 334 appears darker than the surrounding iris 336. By contrast, an on-axis illumination source (e.g., non-visible or low-visibility IR or NIR) may be used to create a ‘bright pupil’ effect, where the pupil of the user appears brighter than the surrounding iris. More specifically, IR or NIR illumination from on-axis illumination source 318 illuminates the retroreflective tissue of the retina 338 of the eye, which reflects the light back through the pupil, forming a bright image 340 of the pupil. Beam-turning optics 342 of see-through display panel 300 may be used to enable eye-imaging camera 316 and on-axis illumination source 318 to share a common optical axis (A), despite their arrangement on a periphery of see-through display panel 300.

Digital image data received from eye-imaging camera 316 may be conveyed to associated logic in an on-board controller or in a remote device (e.g., a remote computing device) accessible to the on-board controller via a communications network. There, the image data may be processed to resolve such features as the pupil center, pupil outline, and/or one or more specular glints 330 from the cornea. The locations of such features in the image data may be used as input parameters in a model (e.g., a polynomial model or other suitable model) that relates feature position to the gaze axis (V).

In some examples, eye-tracking may be performed for each eye of the user, and an eye-gaze axis may be determined for each eye of the user based on the image data obtained for that eye. A user's focal point may be determined as the intersection of the right-eye gaze axis and the left-eye gaze axis of the user. In another example, a combined eye-gaze axis may be determined as the average of right-eye and left-eye gaze axes. In yet another example, an eye-gaze axis may be determined for a single eye of the user.

See-through display panel 300 may be one of a pair of see-through display panels of a see-through display device, which correspond to right-eye and left-eye see-through display panels. In this example, the various optical componentry described with reference to see-through display panel 300 may be provided in duplicate for a second see-through display panel of the see-through display device. However, some optical components may be shared or multi-tasked between or among a pair of see-through display panels. In another example, see-through display panel 300 may extend over both left and right eyes of a user and may have left-eye and right-eye see-through display regions.

FIG. 4 schematically shows a top view of a user 410 wearing a head-mounted display device 420 within a physical space 430 of a real-world environment. Lines 432 and 434 indicate boundaries of the field of view of the user through see-through display panels of the head-mounted display device. FIG. 4 also shows the real-world objects 442, 444, 446, and 448 within physical space 430 that are within the field of view of user 410.

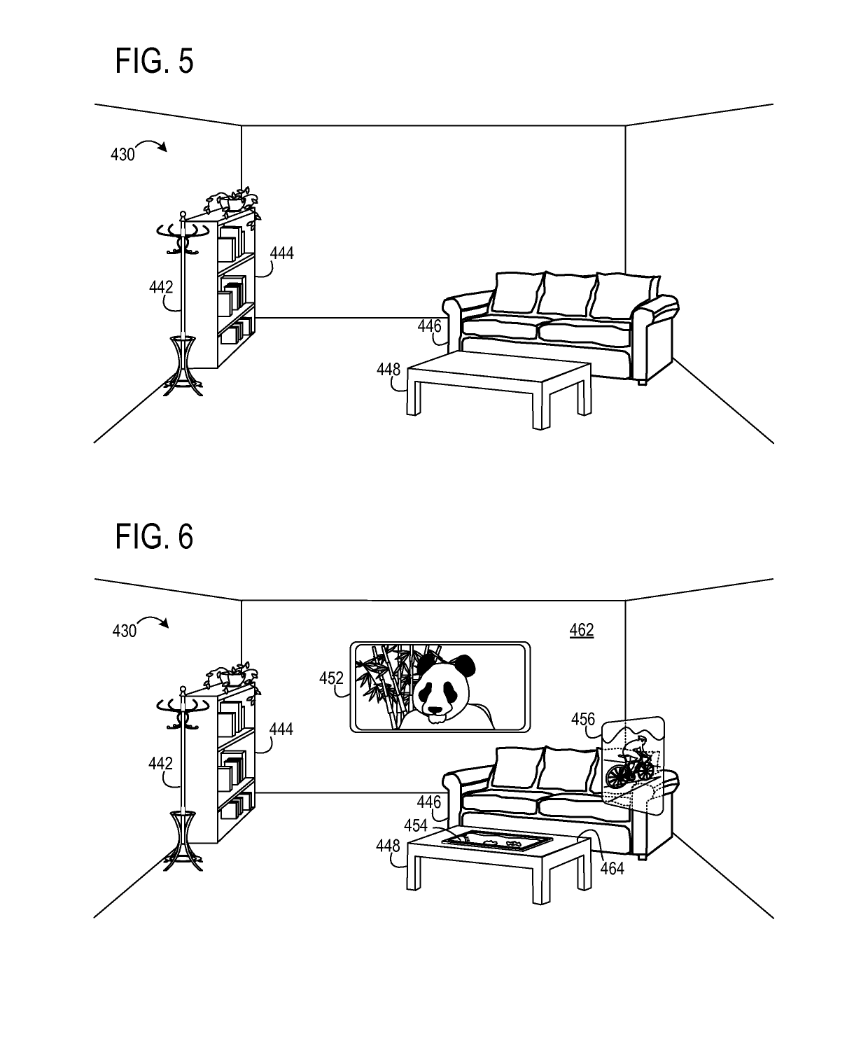

FIG. 5 shows a first-person perspective of user 410 viewing real-world objects 442, 444, 446, and 448 through see-through display panels of display device 420. In FIG. 5, virtual objects are not presented via display device 420. As such, the user is only able to see the real-world objects through the see-through display panels. The user sees such real-world objects because light reflecting from or emitted by the real-world objects is able to pass through the see-through display panels of the display device to the eyes of the user.

FIG. 6 shows the same first-person perspective of user 410, but with display device 420 displaying virtual objects that are visually perceivable by the user. In particular, display device 420 is visually presenting a virtual monitor 452, a virtual monitor 454, and virtual monitor 456. From the perspective of the user, the virtual monitors appear to be integrated with physical space 430.

In particular, FIG. 6 shows virtual monitor 452 rendered to appear as if the virtual monitor is mounted to a wall 462—a typical mounting option for conventional televisions. Virtual monitor 454 is rendered to appear as if the virtual monitor is resting on table surface 464—a typical usage for conventional tablet computing devices. Virtual monitor 456 is rendered to appear as if floating in free space—an arrangement that is not easily achieved with conventional monitors.

Virtual monitors 452, 454, and 456 are provided as non-limiting examples. A virtual monitor may be rendered to have virtually any appearance without departing from the scope of this disclosure. The illusion of a virtual monitor may be created by overlaying one or more textures upon one or more virtual surfaces.

As one example, a virtual monitor may be playing a video stream of moving or static images. A video stream of moving images may be played at a relatively high frame rate so as to create the illusion of live action. As a non-limiting example, a video stream of a television program may be played at thirty frames per second. In some examples, each frame may correspond to a texture that is overlaid upon a virtual surface. A video stream of static images may present the same image on the virtual monitor for a relatively longer period of time. As a non-limiting example, a video stream of a photo slideshow may only change images every five seconds. It is to be understood that virtually any frame rate may be used without departing from the scope of this disclosure.

A virtual monitor may be opaque (e.g., virtual monitor 452 and virtual monitor 454) or partially transparent (e.g., virtual monitor 456). An opaque virtual monitor may be rendered so as to occlude real-world objects that appear to be behind the virtual monitor. A partially transparent virtual monitor may be rendered so that real-world objects or other virtual objects can be viewed through the virtual monitor.

A virtual monitor may be frameless (e.g., virtual monitor 456) or framed (e.g., virtual monitor 452 and virtual monitor 454). A frameless virtual monitor may be rendered with an edge-to-edge screen portion that can play a video stream without any other structure rendered around the screen portion. In contrast, a framed virtual monitor may be rendered to include a frame around the screen. Such a frame may be rendered so as to resemble the appearance of a conventional television frame, computer display frame, movie screen frame, or the like. In some examples, a texture may be derived from a combination of an image representing the screen content and an image representing the frame content.

Both frameless and framed virtual monitors may be rendered without any depth. For example, when viewed from an angle, a depthless virtual monitor will not appear to have any structure behind the surface of the screen (e.g., virtual monitor 456). Furthermore, both frameless and framed virtual monitors may be rendered with a depth, such that when viewed from an angle the virtual monitor will appear to occupy space behind the surface of the screen (virtual monitor 454).

A virtual monitor may include a quadrilateral shaped screen (e.g., rectangular when viewed along an axis that is orthogonal to a front face of the screen) or other suitable shape (e.g., a non-quadrilateral or nonrectangular screen). Furthermore, the screen may be planar or non-planar. In some implementations, the screen of a virtual monitor may be shaped to match the planar or non-planar shape of a real-world object in a physical space (e.g., virtual monitor 452 and virtual monitor 454) or to match the planar or non-planar shape of another virtual object.

Even when a planar screen is rendered, the video stream rendered on the planar screen may be configured to display 3D virtual objects (e.g., to create the illusion of watching a 3D television). An appearance of 3D virtual objects may be accomplished via simulated stereoscopic 3D content—e.g. watching 3D content from a 3D recording so that content appears in 2D and on the plane of the display, but the user's left and right eyes see slightly different views of the video, producing a 3D stereoscopic effect. In some implementations, playback of content may cause virtual 3D objects to actually leave the plane of the display. For example, a movie where the menus actually pop out of the TV into the user's living room. Further, a frameless virtual monitor may be used to visually present 3D virtual objects from the video stream, thus creating an illusion or appearance that the contents of the video stream are playing out in the physical space of the real-world environment.

As another example, a virtual monitor may be rendered in a stationary location relative to real-world objects within the physical space (i.e., world-locked), or a virtual monitor may be rendered so as to move relative to real-world objects within the physical space (i.e., object-locked). A stationary virtual monitor may appear to be fixed within the real-world, such as to a wall, table, or other surface, for example. A stationary virtual monitor that is fixed to a real-world reference frame may also appear to be floating apart from any real-world objects.

A moving virtual monitor may appear to move in a constrained or unconstrained fashion relative to a real-world reference frame. For example, a virtual monitor may be constrained to a physical wall, but the virtual monitor may move along the wall as a user walks by the wall. As another example, a virtual monitor may be constrained to a moving object. As yet another example, a virtual monitor may not be constrained to any physical objects within the real-world environment and may appear to float directly in front of a user regardless of where the user looks (i.e., view-locked). Here, the virtual monitor may be fixed to a reference frame of the user's field of view.

A virtual monitor may be either a private virtual monitor or a public virtual monitor. A private virtual monitor is rendered on only one see-through display device for an individual user so only the user viewing the physical space through the see-through display sees the virtual monitor. A public virtual monitor may be concurrently rendered on one or more other devices, including other see-through displays, so that other people may view a clone of the virtual monitor.

In some implementations, a virtual coordinate system may be mapped to the physical space of the real-world environment such that the virtual monitor appears to be at a particular physical space location. Furthermore, the virtual coordinate system may be a shared coordinate system useable by one or more other head-mounted display devices. In such a case, each separate head-mounted display device may recognize the same physical space location where the virtual monitor is to appear. Each head-mounted display device may then render the virtual monitor at that physical space location within the real-world environment so that two or more users viewing the physical space location through different see-through display devices will see the same virtual monitor in the same place and with the same orientation in relation to the physical space. In other words, the particular physical space location at which one head-mounted display device renders a virtual object (e.g., virtual monitor) will be the same physical space location that another head-mounted display device renders the virtual object (e.g., virtual monitor).

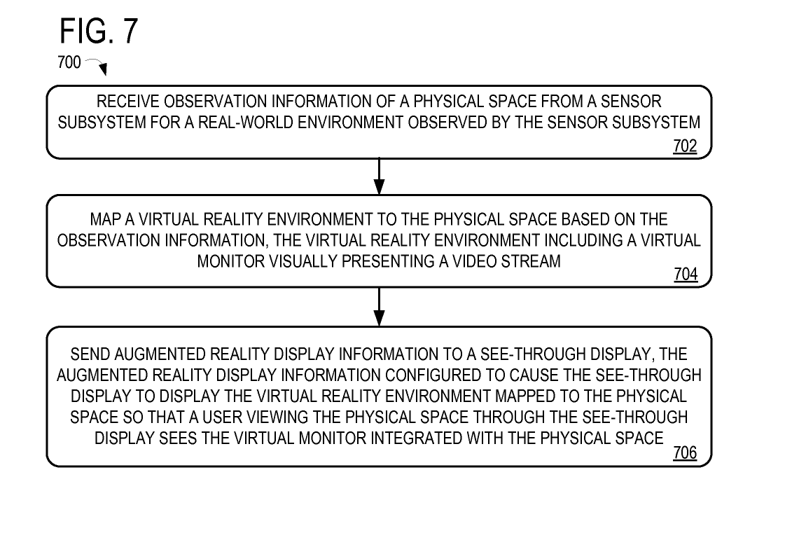

FIG. 7 shows an example method 700 of augmenting reality. In at least some implementations, method 700 or portions thereof may be performed by a virtual reality engine residing locally at a display device, at one or more remote devices in communication with the display device, or may be distributed across the display device and one or more remote devices.

At 702, method 700 includes receiving observation information of a physical space from a sensor subsystem for a real-world environment observed by the sensor subsystem. The observation information may include any information describing the physical space. As non-limiting examples, images from one or more optical cameras (e.g., outward facing optical cameras, such as depth cameras) and/or audio information from one or more microphones may be received. The information may be received from sensors that are part of a head-mounted display device and/or off-board sensor devices that are not part of a head-mounted display device. The information may be received at a head-mounted display device or at an off-board device that communicates with a head-mounted display device.

At 704, method 700 includes mapping a virtual environment to the physical space of the real-world environment based on the observation information. In an example, the virtual environment includes a virtual surface upon which textures may be overlaid to provide the appearance of a virtual monitor visually presenting a video stream. In some implementations, such mapping may be performed by a head-mounted display device or an off-board device that communicates with the head-mounted display device.

At 706, method 700 includes sending augmented reality display information to a see-through display device. The augmented reality display information is configured to cause the see-through display device to display the virtual environment mapped to the physical space of the real-world environment so that a user viewing the physical space through the see-through display device sees the virtual monitor integrated with the physical space. The augmented reality display information may be sent to the see-through display panel(s) from a controller of the head-mounted display device.

FIG. 8 depicts an example processing pipeline for creating a virtual surface overlaid with different right-eye and left-eye textures derived from different 2D images having different perspectives of the same 3D scene. The virtual surface creates an illusion of a 3D virtual monitor. A right-eye 2D image 810 of a scene 812 is captured from a first image-capture perspective 814 (e.g., a right-eye perspective) along first image-capture axis 142 and a left-eye 2D image 816 of the same scene 812 is captured from a second image-capture perspective 818 (e.g., a left-eye perspective) along second image-capture axis 144 that differs from first image-capture perspective 814. In some implementations, scene 812 may be a real world scene imaged by real world cameras. In other implementations, scene 812 may be a virtual scene (e.g., a 3D game world) “imaged” by virtual cameras.

At 820, a portion of right-eye 2D image 810 has been overlaid with a portion of left-eye 2D image 816 for illustrative purposes, enabling comparison between right and left-eye 2D images 812, 816 captured from different perspectives.

A right-eye texture derived from right-eye 2D image 810 is overlaid upon a right-eye virtual object 830. A left-eye texture derived from left-eye 2D image 816 is overlaid upon a left-eye virtual object 832. Right-eye virtual object 830 and left-eye virtual object 832 represent a virtual surface 834 within a virtual environment 836 as viewed from different right-eye and left-eye perspectives. In this example, the virtual surface has a rectangular shape represented by the right-eye virtual object and the left-eye virtual object, each having a quadrilateral shape within which respective right-eye and left-eye textures are overlaid and displayed. At 838, right-eye virtual object 830 has been overlaid with left-eye virtual object 832 for illustrative purposes, enabling comparison of right-eye and left-eye virtual objects as viewed from different perspectives.

An augmented view of a real-world environment is created by displaying the right-eye virtual object overlaid with the right-eye texture via a right-eye see-through display panel depicted schematically at 840, and by displaying the left-eye virtual object overlaid with the left-eye texture via a left-eye see-through display panel depicted schematically at 842. For illustrative purposes, a non-augmented view of the real-world environment is depicted schematically at 850 for the right-eye see-through display panel and at 852 for the left-eye see-through display panel that does not include display of virtual objects or overlaid textures. While the processing pipeline of FIG. 8 is described with reference to see-through display panels that provide augmented views of a real-world environment, it will be understood that the same techniques may be applied to fully immersive virtual reality display devices that do not include see-through displays or to augmented reality display devices that provide indirect, graphically recreated views of the real-world environment rather than a direct view via a see-through display.

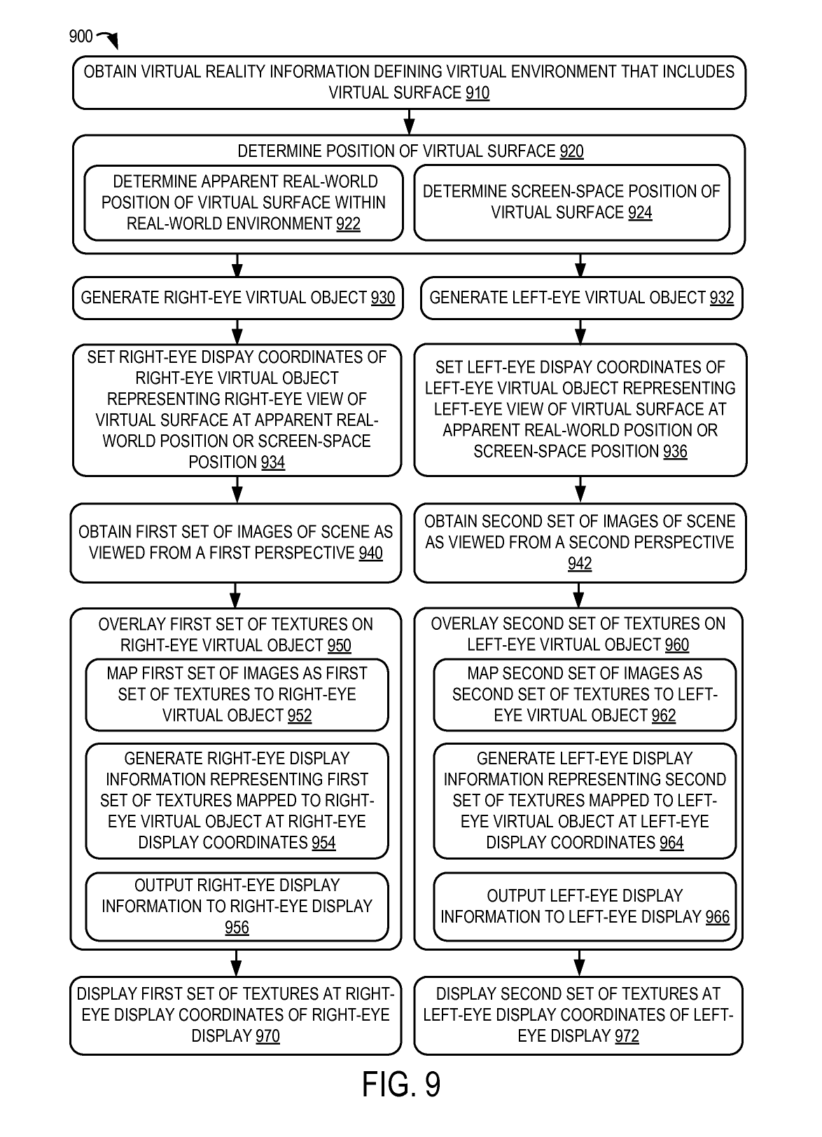

FIG. 9 is an example virtual reality method 900 for providing a 3D stereoscopic viewing experience to a user via a display device. In at least some implementations, method 900 or portions thereof may be performed by a virtual reality engine residing locally at a display device, at one or more remote devices in communication with the display device, or may be distributed across the display device and one or more remote devices.

At 910, method 900 includes obtaining virtual reality information defining a virtual environment. A virtual environment may include one or more virtual surfaces. Virtual surfaces may be defined within a 2D or 3D virtual coordinate space of the virtual environment. Some or all of the virtual surfaces may be overlaid with textures for display to a user viewing the virtual environment via a display device.

In an example, virtual reality information may be obtained by loading the virtual reality information pre-defining some or all of the virtual environment from memory. For example, a virtual environment may include a virtual living room having a virtual surface representing a virtual monitor that is defined by the virtual reality information.

Additionally or alternatively, virtual reality information may be obtained by programmatically generating some or all of the virtual reality information based on observation information received from one or more optical cameras observing a real-world environment. In an example, virtual reality information may be generated based on observation information to map one or more virtual surfaces of the virtual environment to apparent real-world positions within the real-world environment. As a non-limiting example, a virtual surface may be generated based on a size and/or shape of a physical surface observed within the real-world environment.

Additionally or alternatively, virtual reality information may be obtained by programmatically generating some or all of the virtual reality information based on user-specified information that describes some or all of the virtual environment. For example, a user may provide one or more user inputs that at least partially define a position of a virtual surface within the virtual environment and/or an apparent real-world position within a real-world environment.

At 920, method 900 includes determining a position of a virtual surface of the virtual environment upon which textures may be overlaid for display to a user. A position of a virtual surface may be world-locked in which a position of the virtual surface is fixed to an apparent position within a real-world environment or view-locked in which a position of the virtual surface is fixed to a screen-space position of a display device.

At 922, method 900 includes determining an apparent real-world position of the virtual surface within a real-world environment. As previously described with reference to method 700 of FIG. 7, a real-world environment may be visually observed by one or more optical cameras. A 3D model of the real-world environment may be generated based on the observation information received from the optical cameras. The virtual surface (and/or other virtual elements of the virtual environment) is mapped to the 3D model of the real-world environment. The virtual surface may be fixed to an apparent real-world position to provide the appearance of the virtual surface being integrated with and/or simulating physical objects residing within the real-world environment.

In some implementations, an apparent real-world depth of the virtual surface may be programmatically set by the virtual reality engine to reduce or eliminate a difference between an image-capture convergence angle of the first and second image-capture perspectives and a viewing convergence angle of right-eye and left-eye perspectives of the scene overlaid on the virtual surface as viewed by the user through the right-eye and left-eye displays. The apparent real-world depth of the virtual surface is one component of the apparent real-world position of the virtual surface that may be programmatically set by the virtual reality engine.

At 924, method 900 includes determining a screen-space position of the virtual surface. In some implementations, the screen-space position(s) may be dynamically updated as the near-eye display moves so that the virtual surface will appear to remain in the same world-locked, real-world position. In other implementations, a screen-space position of the virtual surface may be view-locked with fixed right-eye display coordinates for a right-eye virtual object representing a right-eye view of the virtual surface and fixed left-eye display coordinates for a left-eye virtual object representing a left-eye view of the virtual surface. A view-locked virtual surface maintains the same relative position within the field of view of the user even if the user's gaze axis changes. As an example, a virtual surface may be view-locked at a screen-space position such that the virtual surface is normal to a combined gaze axis of the user determined as the average of a left-eye gaze axis and a right-eye gaze axis. While a view-locked virtual surface has a fixed screen-space position, the view-locked virtual surface will also have an apparent real-world position.

At 930, the method includes generating a right-eye view of the virtual surface representing an appearance of the virtual surface positioned at the apparent real-world position or screen-space position as viewed from a right-eye perspective. At 932, the method includes generating a left-eye view of the virtual surface representing an appearance of the virtual surface positioned at the apparent real-world position or screen-space position as viewed from a left-eye perspective.

At 934, the method includes setting right-eye display coordinates of the right-eye virtual object representing a right-eye view of a virtual surface of the virtual environment at the apparent real-world position. As previously described with reference to FIG. 2, a right-eye display is configured to display the right-eye virtual object at the right-eye display coordinates.

At 936, the method includes setting left-eye display coordinates of the left-eye virtual object representing a left-eye view of the virtual surface at the same apparent real-world position. As previously described with reference to FIG. 2, a left-eye display is configured to display the left-eye virtual object at the left-eye display coordinates. The right-eye virtual object and the left-eye virtual object cooperatively create an appearance of the virtual surface positioned at the apparent real-world position or screen-space position perceivable by a user viewing the right and left displays.

In an example, the left-eye display coordinates are set relative to the right-eye display coordinates as a function of the apparent real-world position at 920. Right-eye display coordinates and left-eye display coordinates may be determined based on a geometric relationship between a right-eye perspective provided by the right-eye display, a left-eye perspective provided by the left-eye display, and a virtual distance between the right-eye and left-eye perspectives and the apparent real-world position of the virtual surface. In general, the relative coordinates of the right and left eye displays may be shifted relative to one another to change the apparent depth at which the illusion of the virtual surface will be created.

At 940, the method includes obtaining a first set of images of a scene as viewed from a first perspective. The first set of images may include one or more 2D images of the scene captured from the first perspective. The first set of images may take the form of a right-eye set of images and the first perspective may be referred to as a first or right-eye image-capture perspective.

At 942, the method includes obtaining a second set of images of the scene as viewed from a second perspective that is different than the first perspective. The second set of images may include one or more 2D images of the same scene captured from the second perspective. The second set of images may take the form of a left-eye set of images and the second perspective may be referred to as a second or left-eye image-capture perspective.

A scene captured from first and second perspectives as first and second image sets may include a static or dynamically changing 3D real-world or virtual scene. Within the context of a 3D video content item, paired first and second images of respective first and second image sets may correspond to paired right-eye and left-eye frames encoded within the 3D video content item. Within the context of a navigable 3D virtual world of a game or other virtual world, paired first and second images of respective first and second image sets may be obtained by rendering views of the 3D virtual world from two different perspectives corresponding to the first and second perspectives.

In some examples, the first and second sets of images may each include a plurality of time-sequential 2D images corresponding to frames of a video content item. Paired first and second images provide different perspectives of the same scene at the same time. However, scenes may change over time and across a plurality of time-sequential paired images. Within this context, a “first perspective” of the first set of images and a “second perspective” of the second set of images may each refer to a static perspective as well as a non-static perspective of a single scene or a plurality of different scenes that change over a plurality of time-sequential images.

In some implementations, right-eye and left-eye image-capture perspectives may have a fixed geometric relationship relative to each other (e.g., to provide a consistent field of view), but may collectively provide time-varying perspectives of one or more scenes of a virtual world (e.g. to view aspects of a scene from different vantage points). Right-eye and left-eye image-capture perspectives may be defined, at least in part, by user input (e.g., a user providing a user input controlling navigation of a first-person view throughout a 3D virtual world) and/or by a state of the virtual world (e.g., right-eye and left-eye image-capture perspectives may be constrained to a particular path throughout a scene). Control of right-eye and left-eye image-capture perspectives will be described in further detail with reference to FIGS. 10-14.

At 950, method 900 includes overlaying a first set of textures derived from the first set of images on the right-eye virtual object. Each texture of the first set of textures may be derived from a respective 2D image of the scene as viewed from the first perspective. In examples where the first set of images is a first set of time-sequential images, each texture of the first set of textures may be one of a plurality of time-sequential textures of a first set of time-sequential textures.

Overlaying the first set of textures at 950 may include one or more of sub-processes 952, 954, and 956. At 952, method 900 includes mapping the first set of textures to the right-eye virtual object. Each texture of set of textures may be mapped to the right-eye virtual object for a given rendering of the virtual object to a display in which multiple renderings of the virtual object may be sequentially displayed to form a video. At 954, method 900 includes generating right-eye display information representing the first set of textures mapped to the right-eye virtual object at the right-eye display coordinates. Process 954 may include rendering an instance of the right-eye virtual object for each texture of the first set of textures. At 956, method 900 includes outputting the right-eye display information to the right-eye display for display of the first set of textures at the right-eye display coordinates.

At 960, method 900 includes overlaying a second set of textures derived from the second set of images on the left-eye virtual object. Each texture of the second set of textures may be derived from a respective 2D image of the same scene as viewed from the second perspective that is different than the first perspective. In examples where the second set of images is a second set of time-sequential images, each texture of the second set of textures may be one of a plurality of time-sequential textures of a second set of time-sequential textures.

Overlaying the second set of textures at 960 may include one or more of sub-processes 962, 964, and 966. At 962, method 900 includes mapping the second set of textures to the left-eye virtual object. At 964, method 900 includes generating left-eye display information representing the second set of textures mapped to the left-eye virtual object at the left-eye display coordinates. Process 964 may include rendering an instance of the left-eye virtual object for each texture of the second set of textures. At 966, method 900 includes outputting the left-eye display information to the left display panel for display of the second set of textures at the left-eye display coordinates.

At 958, method 900 includes the right-eye display displaying the first set of textures at the right-eye display coordinates as defined by the right-eye display information.

At 968, method 900 includes the left-eye display displaying the second set of textures at the left-eye display coordinates as defined by the left-eye display information.

Within the context of video content items or other dynamically changing media content items, a first set of time-sequential textures may be time-sequentially overlaid on the right-eye virtual object, and a second set of time-sequential textures may be time-sequentially overlaid on the left-eye virtual object to create an appearance of a pseudo 3D video perceivable on the virtual surface by a user viewing the right-eye and left-eye displays. Paired textures derived from paired images of each set of time-sequential images may be concurrently displayed as right-eye and left-eye texture-pairs via respective right-eye and left-eye displays.

FIG. 10 is a flow diagram depicting an example method of changing an image-capture perspective and/or an apparent real-world position of a virtual surface. In at least some implementations, the method of FIG. 10 or portions thereof may be performed by a virtual reality engine residing locally at a display device, at one or more remote devices in communication with the display device, or may be distributed across the display device and one or more remote devices.

At 1010, the method includes determining a gaze axis and/or detecting changes to the gaze axis. A gaze axis may include an eye-gaze axis of an eye of a user or a device-gaze axis of a display device (e.g., a head-mounted display device). Example eye-tracking techniques for detecting an eye-gaze axis were previously described with reference to FIG. 3. In some implementations, a device-gaze axis may be detected by receiving sensor information output by a sensor subsystem that indicates a change in orientation and/or position of the display device. As one example, the sensor information may be received from one or more outward facing optical cameras of the display device and/or one or more off-board optical cameras imaging a physical space that contains the user and/or display device. As another example, the sensor information may be received from one or more accelerometers/inertial sensors of the display device. Sensor information may be processed on-board or off-board the display device to determine a gaze axis, which may be periodically referenced to detect changes to the gaze axis. Such changes may be measured as a direction and magnitude of the change.

At 1020, for world-locked virtual surfaces, the method includes changing a first image-capture perspective and a second image-capture perspective responsive to changing of the gaze axis, while maintaining the apparent real-world position of the virtual surface. In this example, the virtual reality system may update the first and second image-capture perspectives responsive to changing of the gaze axis to obtain updated first and second images and derived textures for the updated first and second image-capture perspectives. Additionally, the virtual reality system may generate updated right-eye and left-eye virtual objects and/or set updated right-eye and left-eye display coordinates responsive to changing of the gaze axis to create an appearance of the virtual surface rotating and/or translating within the field of view of the user.

Alternatively, for view-locked virtual surfaces, at 1030, the method includes changing the apparent real-world, view-locked position of the virtual surface responsive to changing of the gaze axis. In view-locked implementations, display coordinates of right-eye and left-eye virtual objects representing the virtual surface have fixed display coordinates responsive to the changing of the gaze axis. In some examples, first and second image-capture perspectives may additionally be changed responsive to changing of the gaze axis. In other examples, first and second image-capture perspectives may be maintained responsive to changing of the gaze axis.

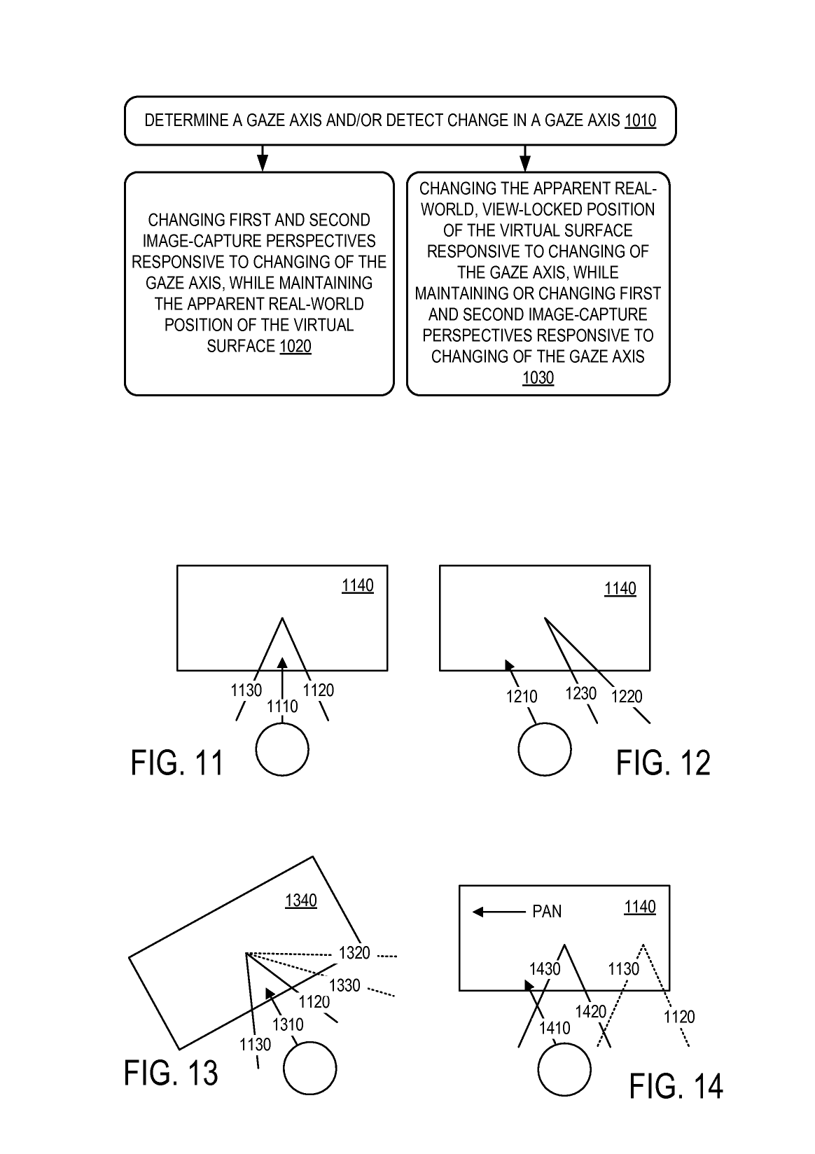

FIGS. 11-14 depict example relationships between a gaze axis, image-capture axes of right-eye and left-eye image-capture perspectives, and an apparent real-world position of a virtual surface. In some implementations, image-capture perspectives and/or an apparent real-world position of a virtual surface may be changed responsive to user input.

User input for controlling a positioning of the image-capture perspectives may include a gaze axis of the user, a game controller input, a voice command, or other suitable user input. While some pre-recorded 3D video content items may not permit changing of the image-capture perspectives, 3D media content items, such as games involving navigable virtual worlds may enable image-capture perspectives to be dynamically changed at runtime.

Changing image-capture perspectives may include rotating and/or translating left-eye and right-eye image-capture perspectives within a virtual world or relative to a scene. Typically, changing image capture perspectives may include maintaining the same relative spacing and/or angle between right-eye and left-eye image-capture perspectives responsive to user input and/or state of the virtual world. However, the spacing and/or angle between right-eye and left-eye image-capture perspectives may be changed responsive to user input and/or state of the virtual world (e.g., game state).

FIG. 11 depicts an initial relationship between a gaze axis 1110, first and second image-capture axes 1120, 1130, and an apparent real-world position of virtual surface 1140. A gaze axis may refer to an eye-gaze axis or a device-gaze axis, and may be measured by eye-tracking and/or device-tracking techniques.

FIG. 12 depicts an example in which first and second image-capture perspectives are changed responsive to changing of the gaze axis, while maintaining the apparent real-world position of a world-locked virtual surface. In FIG. 12, gaze axis 1210 is rotated to the left relative to the initial relationship of gaze axis 1110 depicted in FIG. 11. Responsive to the changing gaze axis, first and second image-capture axes 1220, 1230 are changed (e.g., rotated) as compared to first and second viewing axes 1120, 1130 of FIG. 11, while the same apparent real-world position of virtual surface 1140 is maintained. First and second image-capture axes 1120, 1230 may be changed by virtually moving the virtual cameras used to render the scene (e.g., translate right while rotating left). The example depicted in FIG. 12 provides the effect of the virtual surface being a virtual monitor that appears to be fixed within the real-world environment, but the vantage point of the virtual world displayed by the virtual monitor changes responsive to the user changing the gaze axis. This example may provide the user with the ability to look around a virtual environment that is displayed on a virtual surface that is maintained in a fixed position.

In contrast to the world-locked virtual surface of FIG. 12, FIG. 13 depicts an example of a view-locked virtual surface in which the same right and left image-capture perspectives represented by first and second viewing axes 1120, 1130 are maintained responsive to a change in gaze axis 1310. In FIG. 13, an apparent real-world position of virtual surface 1340 changes responsive to gaze axis 1310 changing relative to gaze axis 1110 of FIG. 11. Virtual surface 1340 is rotated with gaze axis 1310 to provide the same view to the user. As an example, virtual surface 1340 may be visually represented by a right-eye virtual object and a left-eye virtual object having fixed display coordinates within right-eye and left-eye displays. This example provides the effect of the virtual surface changing apparent position within the real-world environment, but the vantage point of the virtual world does not change responsive to the changing gaze axis.

In other implementations, right and left image-capture perspectives may be changed based on and responsive to the gaze axis changing. First and second image-capture axes 1320, 1330 of changed right and left image-capture perspectives are depicted in FIG. 13. First and second image-capture axes 1320, 1330 have rotated in this example to the left relative to image-capture axes 1120, 1130 to provide the user with the appearance of changing right-eye and left-eye perspectives within the virtual world. This example provides the effect of the virtual surface changing apparent position within the real-world environment, while at the same time providing a rotated view of the virtual world responsive to the changing gaze axis. As an example, as a user looks forward, the virtual surface in front of the user may display a pseudo-3D view out the windshield of a race car; as the user looks to the left, the virtual surface may move from in front of the user to the user's left, and the virtual surface may display a pseudo-3D view out the side-window of the race car.

FIG. 14 depicts another example of a world-locked virtual surface with panning performed responsive to changing of the gaze axis. As with the example of FIG. 12, the apparent real-world position of world-locked virtual surface 1140 is maintained responsive to a change in gaze axis 1410 relative to the initial gaze axis 1110 of FIG. 11. In FIG. 14, gaze axis 1410 is rotated to the left. Responsive to the changing gaze axis, first and second viewing axes 1420, 1430 of first and second image-capture perspectives are translated to the left (i.e., panned) as compared to first and second viewing axes 1120, 1130 of FIG. 11, while the same apparent real-world position of virtual surface 1140 is maintained. In some implementations, left-eye and right-eye image-capture axes may be both rotated (e.g., as depicted in FIG. 12) and translated (e.g., as depicted in FIG. 14) responsive to a changing gaze axis.

It is to be understand that changing of the six-degree-of-freedom (6DOF) position/orientation of the virtual surface in the real world may be combined with any changing of the 6DOF virtual camera position/orientation within the virtual world. Moreover, any desired 6DOF real world change to the virtual surface and/or any 6DOF virtual world change to the virtual camera may be a function of any user input.

A change in gaze axis (or other user input) may have a magnitude and direction that is reflected in a rotational change in image-capture perspectives, translation change in image-capture perspectives (e.g., panning), and/or apparent real-world position of a virtual surface. A direction and magnitude of change in image-capture perspectives, panning, and/or apparent real-world position of a virtual surface may be based on and responsive to a direction and magnitude of change of the gaze axis. In some examples, a magnitude of a change in image-capture perspectives, panning, and/or apparent real-world position of a virtual surface may be scaled to a magnitude of a change in gaze axis by applying a scaling factor. A scaling factor may increase or reduce a magnitude of a change in image-capture perspectives, panning, and/or apparent real-world position of a virtual surface for a given magnitude of change of a gaze axis.

Returning to display device 200 of FIG. 2, logic subsystem 230 may be operatively coupled with the various components of display device 200. Logic subsystem 230 may receive signal information from the various components of display device 200, process the information, and output signal information in processed or unprocessed form to the various components of display device 200. Logic subsystem 230 may additionally manage electrical energy/power delivered to the various components of display device 200 to perform operations or processes as defined by the instructions.

Logic subsystem 230 may communicate with a remote computing system via communications subsystem 250 to send and/or receive signal information over a communications network. In some examples, at least some information processing and/or control tasks relating to display device 200 may be performed by or with the assistance of one or more remote computing devices. As such, information processing and/or control tasks may for display device 200 may be distributed across on-board and remote computing systems.

Sensor subsystem 220 of display device 200 may further include one or more accelerometers/inertial sensors and/or one or more microphones. Outward-facing optical cameras and inward-facing optical cameras, such as 222, 224 may include infrared, near-infrared, and/or visible light cameras. As previously described, outward-facing camera(s) may include one or more depth cameras, and/or the inward-facing cameras may include one or more eye-tracking cameras. In some implementations, an on-board sensor subsystem may communicate with one or more off-board sensors that send observation information to the on-board sensor subsystem. For example, a depth camera used by a gaming console may send depth maps and/or modeled virtual body models to the sensor subsystem of the display device.

Display device 200 may include one or more output devices 260 in addition to display panels 210, 212, such as one or more illumination sources, one or more audio speakers, one or more haptic feedback devices, one or more physical buttons/switches and/or touch-based user input elements. Display device 200 may include an energy subsystem that includes one or more energy storage devices, such as batteries for powering display device 200 and its various components.

Display device 200 may optionally include one or more audio speakers. As an example, display device 200 may include two audio speakers to enable stereo sound. Stereo sound effects may include positional audio hints, as an example. In other implementations, the head-mounted display may be communicatively coupled to an off-board speaker. In either case, one or more speakers may be used to play an audio stream that is synced to a video stream played by a virtual monitor. For example, while a virtual monitor plays a video stream in the form of a television program, a speaker may play an audio stream that constitutes the audio component of the television program.

The volume of an audio stream may be modulated in accordance with a variety of different parameters. As one example, volume of the audio stream may be modulated inversely proportional to a distance between the see-through display and an apparent real-world position at which the virtual monitor appears to be located to a user viewing the physical space through the see-through display. In other words, sound can be localized so that as a user gets closer to the virtual monitor, the volume of the virtual monitor will increase. As another example, volume of the audio stream may be modulated in proportion to a directness that the see-through display is viewing a physical-space location at which the virtual monitor appears to be located to the user viewing the physical space through the see-through display. In other words, the volume increases as the user more directly looks at the virtual monitor.

When two or more virtual monitors are mapped to positions near a user, the respective audio streams associated with the virtual monitors may be mixed together or played independently. When mixed together, the relative contribution of any particular audio stream may be weighted based on a variety of different parameters, such as proximity or directness of view. For example, the closer a user is to a particular virtual monitor and/or the more directly the user looks at the virtual monitor, the louder the volume associated with that virtual monitor will be played.

When played independently, an audio stream associated with a particular virtual monitor may be played instead of the audio stream(s) associated with other virtual monitor(s) based on a variety of different parameters, such as proximity and/or directness of view. For example, as a user looks around a physical place in which several virtual monitors are rendered, only the audio stream associated with the virtual monitor that is most directly in the user's field of vision may be played. As previously described, eye-tracking may be used to more accurately assess where a user's focus is directed, and such focus may serve as a parameter for modulating volume.

A virtual monitor may be controlled responsive to commands recognized via the sensor subsystem. As non-limiting examples, commands recognized via the sensor subsystem may be used to control virtual monitor creation, virtual monitor positioning (e.g., where and how large virtual monitors appear); playback controls (e.g., which content is visually presented, fast forward, rewind, pause, etc.); volume of audio associated with virtual monitor; privacy settings (e.g., who is allowed to see clone virtual monitors; what such people are allowed to see); screen capture, sending, printing, and saving; and/or virtually any other aspect of a virtual monitor.

As introduced above, a sensor subsystem may include or be configured to communicate with one or more different types of sensors, and each different type of sensor may be used to recognize commands for controlling a virtual monitor. As non-limiting examples, the virtual monitor may be controlled responsive to audible commands recognized via a microphone, hand gesture commands recognized via a camera, and/or eye gesture commands recognized via a camera.

The types of commands and the way that such commands control the virtual monitors may vary without departing from the scope of this disclosure. To create a virtual monitor, for instance, a forward-facing camera may recognize a user framing a scene with an imaginary rectangle between a left hand in the shape of an L and a right hand in the shape of an L. When this painter's gesture with the L-shaped hands is made, a location and size of a new virtual monitor may be established by projecting a rectangle from the eyes of the user to the rectangle established by the painter's gesture, and on to a wall behind the painter's gesture.

As another example, the location and size of a new virtual monitor may be established by recognizing a user tapping a surface to establish the corners of a virtual monitor. As yet another example, a user may speak the command “new monitor,” and a virtual monitor may be rendered on a surface towards which eye-tracking cameras determine a user is looking.

Once a virtual monitor is rendered and playing a video stream, a user may speak commands such as “pause,” “fast forward,” “change channel,” etc. to control the video stream. As another example, the user may make a stop-sign hand gesture to pause playback, swipe a hand from left to right to fast forward, or twist an outstretched hand to change a channel. As yet another example, a user may speak “split” or make a karate chop gesture to split a single virtual monitor into two virtual monitors that may be moved to different physical space locations.

Display device 200 may include one or more features that allow the head-mounted display to be worn on a user's head. In the illustrated example, head-mounted display 200 takes the form of eye glasses and includes a nose rest 292 and ear rests 290a and 290b. In other implementations, a head-mounted display may include a hat, visor, or helmet with an in-front-of-the-face see-through visor. Furthermore, while described in the context of a head-mounted see-through display device, the concepts described herein may be applied to see-through displays that are not head mounted (e.g., a windshield) and to displays that are not see-through (e.g., an opaque display that renders real objects observed by a camera with virtual objects not within the camera's field of view).

The above described techniques, processes, operations, and methods may be tied to a computing system that is integrated into a head-mounted display and/or a computing system that is configured to communicate with a head-mounted display. In particular, the methods and processes described herein may be implemented as a computer application, computer service, computer API, computer library, and/or other computer program product.

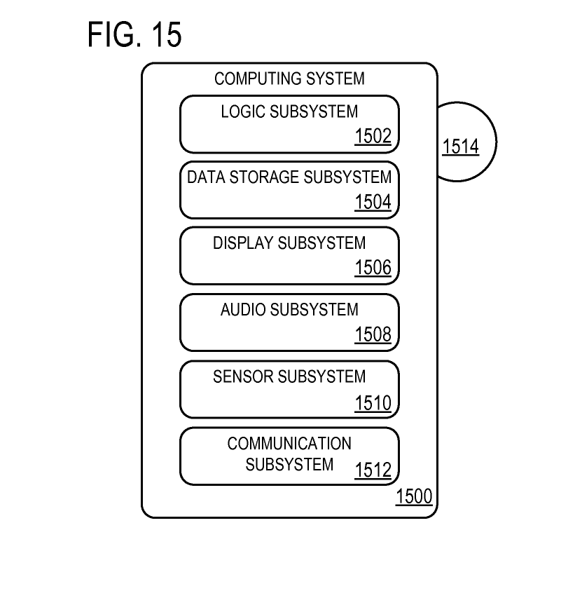

FIG. 15 schematically shows a non-limiting example of a computing system 1500 that may perform one or more of the above described methods and processes. Computing system 1500 may include or form part of a virtual reality system, as previously described. Computing system 1500 is shown in simplified form. It is to be understood that virtually any computer architecture may be used without departing from the scope of this disclosure. In different implementations, computing system 1500 may take the form of an onboard head-mounted display computer, mainframe computer, server computer, desktop computer, laptop computer, tablet computer, home entertainment computer, network computing device, mobile computing device, mobile communication device, gaming device, etc.

Computing system 1500 includes a logic subsystem 1502 and a data storage subsystem 1504. Computing system 1500 may optionally include a display subsystem 1506, audio subsystem 1508, sensor subsystem 1510, communication subsystem 1512, and/or other components not shown in FIG. 15.

Logic subsystem 1502 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data storage subsystem 1504 may include one or more physical, non-transitory, devices configured to hold data and/or instructions executable by the logic subsystem to implement the herein described methods and processes. When such methods and processes are implemented, the state of data storage subsystem 1504 may be transformed (e.g., to hold different data).

Data storage subsystem 1504 may include removable media and/or built-in devices. Data storage subsystem 1504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data storage subsystem 1504 may include devices with one or more of the following characteristics: volatile, nonvolatile, dynamic, static, read/write, read-only, random access, sequential access, location addressable, file addressable, and content addressable. In some implementations, logic subsystem 1502 and data storage subsystem 1504 may be integrated into one or more common devices, such as an application specific integrated circuit or a system on a chip.

FIG. 15 also shows an aspect of the data storage subsystem in the form of removable computer-readable storage media 1514, which may be used to store and/or transfer data and/or instructions executable to implement the herein described methods and processes. Removable computer-readable storage media 1514 may take the form of CDs, DVDs, HD-DVDs, Blu-Ray Discs, EEPROMs, and/or floppy disks, among others.

It is to be appreciated that data storage subsystem 1504 includes one or more physical, non-transitory devices. In contrast, in some implementations aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

Software modules or programs may be implemented to perform one or more particular functions. In some cases, such a module or program may be instantiated via logic subsystem 1502 executing instructions held by data storage subsystem 1504. It is to be understood that different modules or programs may be instantiated from the same application, service, code block, object, library, routine, API, function, etc. Likewise, the same module or program may be instantiated by different applications, services, code blocks, objects, routines, APIs, functions, etc. The terms “module” and “program” are meant to encompass individual or groups of executable files, data files, libraries, drivers, scripts, database records, etc.

When included, display subsystem 1506 may be used to present a visual representation of data held by data storage subsystem 1504. As the herein described methods and processes change the data held by the data storage subsystem, and thus transform the state of the data storage subsystem, the state of display subsystem 1506 may likewise be transformed to visually represent changes in the underlying data. Display subsystem 1506 may include one or more display devices utilizing virtually any type of technology. Such display devices may be combined with logic subsystem 1502 and/or data storage subsystem 1504 in a shared enclosure (e.g., a head-mounted display with onboard computing), or such display devices may be peripheral display devices (a head-mounted display with off-board computing).

As one non-limiting example, the display subsystem may include image-producing elements (e.g. see-through OLED displays) located within lenses of a head-mounted display. As another example, the display subsystem may include a light modulator on an edge of a lens, and the lens may serve as a light guide for delivering light from the light modulator to an eye of a user. In either case, because the lenses are at least partially transparent, light may pass through the lenses to the eyes of a user, thus allowing the user to see through the lenses.

The sensor subsystem may include and/or be configured to communicate with a variety of different sensors. For example, the head-mounted display may include at least one inward facing optical camera or sensor and/or at least one outward facing optical camera or sensor. The inward facing sensor may be an eye tracking image sensor configured to acquire image data to allow a viewer's eyes to be tracked. The outward facing sensor may detect gesture-based user inputs. For example, an outward facing sensor may include a depth camera, a visible light camera, or another position tracking camera. Further, such outward facing cameras may have a stereo configuration. For example, the head-mounted display may include two depth cameras to observe the physical space in stereo from two different angles of the user's perspective. In some implementations, gesture-based user inputs also may be detected via one or more off-board cameras.

Further, an outward facing image sensor (e.g., optical camera) may capture images of a physical space, which may be provided as input to an onboard or off-board 3D modeling system. A 3D modeling system may be used to generate a 3D model of the physical space. Such 3D modeling may be used to localize a precise position of a head-mounted display in a physical space so that virtual monitors may be rendered so as to appear in precise locations relative to the physical space. Furthermore, 3D modeling may be used to accurately identify real-world surfaces to which virtual monitors can be constrained. To facilitate such 3D modeling, the sensor subsystem may optionally include an infrared projector to assist in structured light and/or time of flight depth analysis.

The sensor subsystem may also include one or more motion sensors to detect movements of a viewer's head when the viewer is wearing the head-mounted display. Motion sensors may output motion data for tracking viewer head motion and eye orientation, for example. As such, motion data may facilitate detection of tilts of the user's head along roll, pitch and/or yaw axes. Further, motion sensors may enable a position of the head-mounted display to be determined and/or refined. Likewise, motion sensors may also be employed as user input devices, such that a user may interact with the head-mounted display via gestures of the neck, head, or body. Non-limiting examples of motion sensors include an accelerometer, a gyroscope, a compass, and an orientation sensor. Further, the a head-mounted and/or wearable device may be configured with global positioning system (GPS) capabilities.

Audio subsystem 1508 may include or be configured to utilize one or more speakers for playing audio streams and/or other sounds as discussed above. The sensor subsystem may also include one or more microphones to allow the use of voice commands as user inputs.

When included, communication subsystem 1512 may be configured to communicatively couple computing system 1500 with one or more other computing devices. Communication subsystem 1512 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some implementations, the communication subsystem may allow computing system 1500 to send and/or receive messages to and/or from other devices via a network such as the Internet.

In an example, a virtual reality system comprises a right near-eye display configured to display a right-eye virtual object at right-eye display coordinates; a left near-eye display configured to display a left-eye virtual object at left-eye display coordinates, the right-eye virtual object and the left-eye virtual object cooperatively creating an appearance of a virtual surface perceivable by a user viewing the right and left near-eye displays; a virtual reality engine configured to: set the left-eye display coordinates relative to the right-eye display coordinates as a function of an apparent real-world position of the virtual surface; and overlay a first texture on the right-eye virtual object and a second texture on the left-eye virtual object, the first texture derived from a two-dimensional image of a scene as viewed from a first perspective, and the second texture derived from a two-dimensional image of the scene as viewed from a second perspective, different than the first perspective. In this example or any other example, the right near-eye display is a right near-eye see-through display of a head-mounted augmented reality display device, and the left near-eye display is a left near-eye see-through display of the head-mounted augmented reality display device. In this example or any other example, the virtual reality system further comprises a sensor subsystem including one or more optical sensors configured to observe a real-world environment and output observation information for the real-world environment; and the virtual reality engine is further configured to: receive the observation information for the real-world environment observed by the sensor subsystem, and map the virtual surface to the apparent real-world position within the real-world environment based on the observation information. In this example or any other example, the virtual reality engine is further configured to map the virtual surface to the apparent real-world position by world-locking the apparent real-world position of the virtual surface to a fixed real-world position within the real-world environment. In this example or any other example, a screen-space position of the virtual surface is view-locked with fixed right-eye and left-eye display coordinates. In this example or any other example, the virtual reality engine is further configured to programmatically set an apparent real-world depth of the virtual surface to reduce or eliminate a difference between an image-capture convergence angle of the first and second perspectives of the scene and a viewing convergence angle of right-eye and left-eye perspectives of the scene overlaid on the virtual surface as viewed by the user through the right and left near-eye displays. In this example or any other example, a first image-capture axis of the first perspective is skewed relative to a gaze axis from a right eye to the apparent real-world position of the virtual surface; and a second image-capture axis of the second perspective is skewed relative to a gaze axis from a left eye to the apparent real-world position of the virtual surface. In this example or any other example, the first texture is one of a plurality of time-sequential textures of a first set of time-sequential textures, and the second texture is one of a plurality of time-sequential textures of a second set of time-sequential textures; and the virtual reality engine is further configured to time-sequentially overlay the first set of textures on the right-eye virtual object and the second set of textures on the left-eye virtual object to create an appearance of pseudo-three-dimensional video perceivable on the virtual surface by the user viewing the right and left near-eye displays. In this example or any other example, the virtual reality engine is further configured to: receive an indication of a gaze axis from a sensor subsystem, the gaze axis including an eye-gaze axis or a device-gaze axis; and change the first perspective and the second perspective responsive to changing of the gaze axis while maintaining the apparent real-world position of the virtual surface. In this example or any other example, the virtual reality engine is further configured to: receive an indication of a gaze axis from a sensor subsystem, the gaze axis including an eye-gaze axis or a device-gaze axis; and change the first perspective and the second perspective responsive to changing of the gaze axis; and change the apparent real-world, view-locked position of the virtual surface responsive to changing of the gaze axis.

In an example, a virtual reality system comprises: a head-mounted display device including a right near-eye see-through display and a left near-eye see-through display; and a computing system that: obtains virtual reality information defining a virtual environment that includes a virtual surface, sets right-eye display coordinates of a right-eye virtual object representing a right-eye view of the virtual surface at an apparent real-world position, sets left-eye display coordinates of a left-eye virtual object representing a left-eye view of the virtual surface at the apparent real-world position, obtains a first set of textures, each texture of the first set derived from a two-dimensional image of a scene, obtains a second set of textures, each texture of the second set derived from a two-dimensional image of the scene captured from a different perspective than a paired two-dimensional image of the first set of textures, maps the first set of textures to the right-eye virtual object, generates right-eye display information representing the first set of textures mapped to the right-eye virtual object at the right-eye display coordinates, outputs the right-eye display information to the right near-eye see-through display for display of the first set of textures at the right-eye display coordinates, maps the second set of textures to the left-eye virtual object, generates left-eye display information representing the second set of textures mapped to the left-eye virtual object at the left-eye display coordinates, and outputs the left-eye display information to the left near-eye see-through display for display of the second set of textures at the left-eye display coordinates. In this example or any other example, the computing system sets the left-eye display coordinates relative to the right-eye display coordinates as a function of the apparent real-world position of the virtual surface. In this example or any other example, the virtual reality system further comprises a sensor subsystem that observes a physical space of a real-world environment of the head-mounted display device; and the computing system further: receives observation information of the physical space observed by the sensor subsystem, and maps the virtual surface to the apparent real-world position within the real-world environment based on the observation information. In this example or any other example, the computing system further: determines a gaze axis based on the observation information, the gaze axis including an eye-gaze axis or a device-gaze axis, and changes the first perspective and the second perspective responsive to changing of the gaze axis while maintaining the apparent real-world position of the virtual surface. In this example or any other example, the computing system further: changes the first perspective and the second perspective responsive to changing of the gaze axis; and changes the apparent real-world, view-locked position of the virtual surface responsive to changing of the gaze axis. In this example or any other example, the first set of textures includes a plurality of time-sequential textures, and the second set of textures includes a plurality of time-sequential textures; and the computing system further time-sequentially overlays the first set of textures on the right-eye virtual object and the second set of textures on the left-eye virtual object to create an appearance of pseudo-three-dimensional video perceivable on the virtual surface by the user viewing the right and left near-eye see-through displays.

In an example, a virtual reality method for a head-mounted see-through display device having right and left near-eye see-through displays, comprises: obtaining virtual reality information defining a virtual environment that includes a virtual surface; setting left-eye display coordinates of the left near-eye see-through display for display of a left-eye virtual object relative to right-eye display coordinates of the right near-eye see-through display for display of a right-eye virtual object as a function of an apparent real-world position of the virtual surface; overlaying a first texture on the right-eye virtual object and a second texture on the left-eye virtual object, the first texture being a two-dimensional image of a scene captured from a first perspective, and the second texture being a two-dimensional image of the scene captured from a second perspective, different than the first perspective; displaying the first texture overlaying the right-eye virtual object at the right-eye display coordinates via the right near-eye see-through display; and displaying the second texture overlaying the left-eye virtual object at the left-eye display coordinates via the left near-eye see-through display. In this example or any other example, the method further comprises observing a physical space via a sensor subsystem; determining a gaze axis based on observation information received from the sensor subsystem, the gaze axis including an eye-gaze axis or a device-gaze axis; and changing the first perspective and the second perspective responsive to changing of the gaze axis, while maintaining the apparent real-world position of the virtual surface. In this example or any other example, the method further comprises: observing a physical space via a sensor subsystem; determining a gaze axis based on observation information received from the sensor subsystem, the gaze axis including an eye-gaze axis or a device-gaze axis changing the first perspective and the second perspective responsive to changing of the gaze axis; and changing the apparent real-world, view-locked position of the virtual surface responsive to changing of the gaze axis. In this example or any other example, the first texture is one of a plurality of time-sequential textures of a first set of time-sequential textures, and wherein the second texture is one of a plurality of time-sequential textures of a second set of time-sequential textures; and the method further includes: time-sequentially overlaying the first set of textures on the right-eye virtual object and the second set of textures on the left-eye virtual object to create an appearance of pseudo-three-dimensional video perceivable on the virtual surface by the user viewing the right and left near-eye displays.

It is to be understood that the configurations and/or approaches described herein are exemplary in nature, and that these specific implementations or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A virtual reality system, comprising:
a right near-eye display configured to display a right-eye virtual object at right-eye display coordinates;
a left near-eye display configured to display a left-eye virtual object at left-eye display coordinates, the right-eye virtual object and the left-eye virtual object cooperatively creating an appearance of a virtual surface perceivable by a user viewing the right and left near-eye displays;
a virtual reality engine configured to:
set the left-eye display coordinates relative to the right-eye display coordinates as a function of an apparent real-world position of the virtual surface; and
overlay a first texture on the right-eye virtual object and a second texture on the left-eye virtual object, the first texture derived from a two-dimensional image of a scene as viewed from a first perspective, and the second texture derived from a two-dimensional image of the scene as viewed from a second perspective, different than the first perspective.

2. The virtual reality system of claim 1, wherein the right near-eye display is a right near-eye see-through display of a head-mounted augmented reality display device, and
wherein the left near-eye display is a left near-eye see-through display of the head-mounted augmented reality display device.

3. The virtual reality system of claim 1, further comprising:
a sensor subsystem including one or more optical sensors configured to observe a real-world environment and output observation information for the real-world environment; and
wherein the virtual reality engine is further configured to:
receive the observation information for the real-world environment observed by the sensor subsystem, and
map the virtual surface to the apparent real-world position within the real-world environment based on the observation information.

4. The virtual reality system of claim 3, wherein the virtual reality engine is further configured to map the virtual surface to the apparent real-world position by world-locking the apparent real-world position of the virtual surface to a fixed real-world position within the real-world environment.

5. The virtual reality system of claim 1, wherein a screen-space position of the virtual surface is view-locked with fixed right-eye and left-eye display coordinates.

6. The virtual reality system of claim 1, wherein the virtual reality engine is further configured to programmatically set an apparent real-world depth of the virtual surface to reduce or eliminate a difference between an image-capture convergence angle of the first and second perspectives of the scene and a viewing convergence angle of right-eye and left-eye perspectives of the scene overlaid on the virtual surface as viewed by the user through the right and left near-eye displays.

7. The virtual reality system of claim 1, wherein a first image-capture axis of the first perspective is skewed relative to a gaze axis from a right eye to the apparent real-world position of the virtual surface; and
wherein a second image-capture axis of the second perspective is skewed relative to a gaze axis from a left eye to the apparent real-world position of the virtual surface.

8. The virtual reality system of claim 1, wherein the first texture is one of a plurality of time-sequential textures of a first set of time-sequential textures, and wherein the second texture is one of a plurality of time-sequential textures of a second set of time-sequential textures; and
wherein the virtual reality engine is further configured to time-sequentially overlay the first set of textures on the right-eye virtual object and the second set of textures on the left-eye virtual object to create an appearance of pseudo-three-dimensional video perceivable on the virtual surface by the user viewing the right and left near-eye displays.

9. The virtual reality system of claim 1, wherein the virtual reality engine is further configured to:
receive an indication of a gaze axis from a sensor subsystem, the gaze axis including an eye-gaze axis or a device-gaze axis; and
change the first perspective and the second perspective responsive to changing of the gaze axis while maintaining the apparent real-world position of the virtual surface.

10. The virtual reality system of claim 1, wherein the virtual reality engine is further configured to:
receive an indication of a gaze axis from a sensor subsystem, the gaze axis including an eye-gaze axis or a device-gaze axis; and
change the first perspective and the second perspective responsive to changing of the gaze axis; and
change the apparent real-world, view-locked position of the virtual surface responsive to changing of the gaze axis.

11. A virtual reality system, comprising:
a head-mounted display device including a right near-eye see-through display and a left near-eye see-through display; and
a computing system that:
obtains virtual reality information defining a virtual environment that includes a virtual surface,
sets right-eye display coordinates of a right-eye virtual object representing a right-eye view of the virtual surface at an apparent real-world position,
sets left-eye display coordinates of a left-eye virtual object representing a left-eye view of the virtual surface at the apparent real-world position,
obtains a first set of textures, each texture of the first set derived from a two-dimensional image of a scene,
obtains a second set of textures, each texture of the second set derived from a two-dimensional image of the scene captured from a different perspective than a paired two-dimensional image of the first set of textures,
maps the first set of textures to the right-eye virtual object,
generates right-eye display information representing the first set of textures mapped to the right-eye virtual object at the right-eye display coordinates,
outputs the right-eye display information to the right near-eye see-through display for display of the first set of textures at the right-eye display coordinates,
maps the second set of textures to the left-eye virtual object,
generates left-eye display information representing the second set of textures mapped to the left-eye virtual object at the left-eye display coordinates, and
outputs the left-eye display information to the left near-eye see-through display for display of the second set of textures at the left-eye display coordinates.

12. The virtual reality system of claim 11, wherein the computing system sets the left-eye display coordinates relative to the right-eye display coordinates as a function of the apparent real-world position of the virtual surface.

13. The virtual reality system of claim 12, further comprising:
a sensor subsystem that observes a physical space of a real-world environment of the head-mounted display device; and
wherein the computing system further:
receives observation information of the physical space observed by the sensor subsystem, and
maps the virtual surface to the apparent real-world position within the real-world environment based on the observation information.

14. The virtual reality system of claim 13, wherein the computing system further:
determines a gaze axis based on the observation information, the gaze axis including an eye-gaze axis or a device-gaze axis, and
changes the first perspective and the second perspective responsive to changing of the gaze axis while maintaining the apparent real-world position of the virtual surface.

15. The virtual reality system of claim 13, wherein the computing system further:
changes the first perspective and the second perspective responsive to changing of the gaze axis; and
changes the apparent real-world, view-locked position of the virtual surface responsive to changing of the gaze axis.

16. The virtual reality system of claim 11, wherein the first set of textures includes a plurality of time-sequential textures, and wherein the second set of textures includes a plurality of time-sequential textures; and
wherein the computing system further time-sequentially overlays the first set of textures on the right-eye virtual object and the second set of textures on the left-eye virtual object to create an appearance of pseudo-three-dimensional video perceivable on the virtual surface by the user viewing the right and left near-eye see-through displays.

17. A virtual reality method for a head-mounted see-through display device having right and left near-eye see-through displays, the method comprising:
obtaining virtual reality information defining a virtual environment that includes a virtual surface;
setting left-eye display coordinates of the left near-eye see-through display for display of a left-eye virtual object relative to right-eye display coordinates of the right near-eye see-through display for display of a right-eye virtual object as a function of an apparent real-world position of the virtual surface;
overlaying a first texture on the right-eye virtual object and a second texture on the left-eye virtual object, the first texture being a two-dimensional image of a scene captured from a first perspective, and the second texture being a two-dimensional image of the scene captured from a second perspective, different than the first perspective;
displaying the first texture overlaying the right-eye virtual object at the right-eye display coordinates via the right near-eye see-through display; and
displaying the second texture overlaying the left-eye virtual object at the left-eye display coordinates via the left near-eye see-through display.

18. The method of claim 17, further comprising:
observing a physical space via a sensor subsystem;
determining a gaze axis based on observation information received from the sensor subsystem, the gaze axis including an eye-gaze axis or a device-gaze axis; and
changing the first perspective and the second perspective responsive to changing of the gaze axis, while maintaining the apparent real-world position of the virtual surface.

19. The method of claim 17, further comprising:
observing a physical space via a sensor subsystem;
determining a gaze axis based on observation information received from the sensor subsystem, the gaze axis including an eye-gaze axis or a device-gaze axis;
changing the first perspective and the second perspective responsive to changing of the gaze axis; and
changing the apparent real-world, view-locked position of the virtual surface responsive to changing of the gaze axis.

20. The method of claim 17, wherein the first texture is one of a plurality of time-sequential textures of a first set of time-sequential textures, and wherein the second texture is one of a plurality of time-sequential textures of a second set of time-sequential textures; and
wherein the method further includes:
time-sequentially overlaying the first set of textures on the right-eye virtual object and the second set of textures on the left-eye virtual object to create an appearance of pseudo-three-dimensional video perceivable on the virtual surface by the user viewing the right and left near-eye displays.
